(19) United States
(12) Patent Application Publication
(10) Pub. No.: US 2016/0093127 A1
(43) Pub. Date: Mar. 31, 2016

(54) ENTRY POINT VALIDATION SYSTEMS AND METHODS

(71) Applicant: NCR Corporation, Duluth, GA (US)

(72) Inventor: Curtis Evans, Atlanta, GA (US)

(21) Appl. No.: 14/499,746

(22) Filed: Sep. 29, 2014

(51) Int. Cl. G07C 9/00

(52) U.S. Cl. CPC G07C 9/00007

(57) ABSTRACT

Various embodiments herein each include at least one of systems, devices, methods, and software for entry point validation. Such embodiments may be implemented at entry points to controlled access areas, such as ticketed events, venues, buildings, rooms, elevators, and the like. One embodiment includes receiving a beacon identifier on a mobile device from a beacon device associated with an entry point. This embodiment further includes transmitting, via a network from the mobile device, the beacon identifier and at least one identifier to a backend system with an entry request to electronically cause a credential to be provided to a computing device associated with an entry point.

### BACKGROUND INFORMATION

Controlling entry through passageways, such as doors, turnstiles, and the like is important in many instances. For example, for one or both of ingress and egress from a building, entry of an event or park, and the like. When many people are attempting entry or exit at the same time, lines may develop. Further, when a credential, such as a key, a card with an embedded chip, ticket, or other credential must be presented, there may be considerable delay. Additionally, when such a credential is required, conventional credentials generally permits anyone in possession thereof to pass.

### SUMMARY

Various embodiments herein each include at least one of systems, devices, methods, and software for entry point validation. Such embodiments may be implemented at entry points to controlled access areas, such as ticketed events, venues, buildings, rooms, elevators, and the like.

One method embodiment includes receiving a beacon identifier on a mobile device from a beacon device associated with an entry point. This embodiment further includes transmitting, via a network from the mobile device, the beacon identifier and at least one identifier to a backend system with an entry request to electronically cause a credential to be provided to a computing device associated with an entry point.

Another method embodiment includes receiving, via a network, an entry request including a beacon identifier and at least one secondary identifier and associating the entry request with an entry point based on the beacon identifier. This embodiment may then determine whether the at least one secondary identifier is associated with an entry permission with regard to the entry point. When the at least one secondary identifier is associated with an entry permission with regard to the entry point, the method of such embodiment includes transmitting an authorization message, via the network to a computing device associated with the entry point.

Another embodiment is in the form of a system. The system of this embodiment includes at least one network interface device, at least one visual output device, at least one processor, and at least one memory. The system includes an instruction set, stored in the memory and executable by the at least one processor to perform data processing activities. The data processing activities in some embodiments include receiving, via the at least one network interface device from a backend system, data indicating a mobile device has been authorized for entry. The data processing activities further include activating the at least one visual output device indicating the mobile device has been authorized for entry.

### BRIEF DESCRIPTION OF THE DRAWINGS

FIG. 1 is a logical block diagram of a system, according to an example embodiment.

FIG. 2 is a block flow diagram of a method, according to an example embodiment.

FIG. 3 is a block flow diagram of a method, according to an example embodiment.

FIG. 4 is a block flow diagram of a method, according to an example embodiment.

FIG. 5 is a block diagram of a computing device, according to an example embodiment.

### DETAILED DESCRIPTION

Various embodiments herein each include at least one of systems, devices, methods, and software for entry point validation. Such embodiments may be implemented at entry points to controlled access areas, such as ticketed events, venues, buildings, rooms, elevators, and the like. In an example embodiment, a positioning beacon device is deployed at or near an entry point that broadcasts a radio signal encoded with entry point identifying data. The positioning beacon device, in some embodiments, may include a radio transceiver device, such as a BLUETOOTH® beacon device. Among others, such beacon devices are available from NCR Corporation of Duluth, Georgia. The positioning beacon device may also, or alternatively, include a WI-FI® Wireless Access Point (WAP) device in some embodiments. The radio signal, or signals, broadcast by the positioning beacon device are received by a mobile device of an individual desiring to enter via the entry point. Some embodiments may include a plurality of positioning beacon devices, each broadcasting unique positioning data, such as positioning beacon device identifiers.

A mobile device app that executes on the mobile device receives the encoded signal from one or more positioning beacon devices and generates an access request. The access request will include data representative of the entry point, such as all or a portion of data of the encoded signal received from one or more positioning beacon devices or data generated or obtained based thereon. The access request may also include other data such as a ticket identifier, a user or user account identifier of the individual desiring entry at the entry point, and other data, depending on the particular embodiment. This other data may include password data or other user credential data. The access request, once generated, may then be transmitted via a network to another computing system that will validate the access request.

The computer system receiving the access request performs validation on the access request. The validation may include validating that a ticket identified in the access request is valid, has not been previously used for entry, and that the user presenting the ticket via their mobile device is the ticket holder. The validation may further include consideration of not only ticket validity, but also whether the ticket is valid at the particular date and time the ticket is presented. For example, the ticket may be valid, but the ticket presented may be valid for a current, past, or future occurrence of the ticketed event. In some other embodiments, the validation may include a validation of whether the user is authorized for entry to a facility on the date and time of presentment. For example, an employee of a bank may be authorized for entry to a bank branch, or an area therein, during normal working hours, but not during weekends or holidays. Regardless of the validation rules that may be implemented in a particular embodiment, validation of the access request is performed. A result of the validation process is then transmitted via the network to one or both of an entry point control system or device and the user's mobile device.

The entry point control system or device, upon receipt of the access request result, performs an action depending on the type of entry point control system or device. The entry point control system or device may simply unlock a door or activate an elevator. In other embodiments, the entry point control system or device may be a signaling device that illuminates green when entry is authorized and red when entry is not authorized. Entry point personnel may then allow the user to pass or prevent them from doing so. In some embodiments, the entry point control system or device may be more sophisticated, including a display device, such as a monitor. The entry point control system or device in such embodiments may receive additional data in the access request result. This additional data may include an image and a name of the user that is either to be allowed or denied entry. The image and name may then be presented via the display enabling entry point personnel to quickly identify and refer to the user by name.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

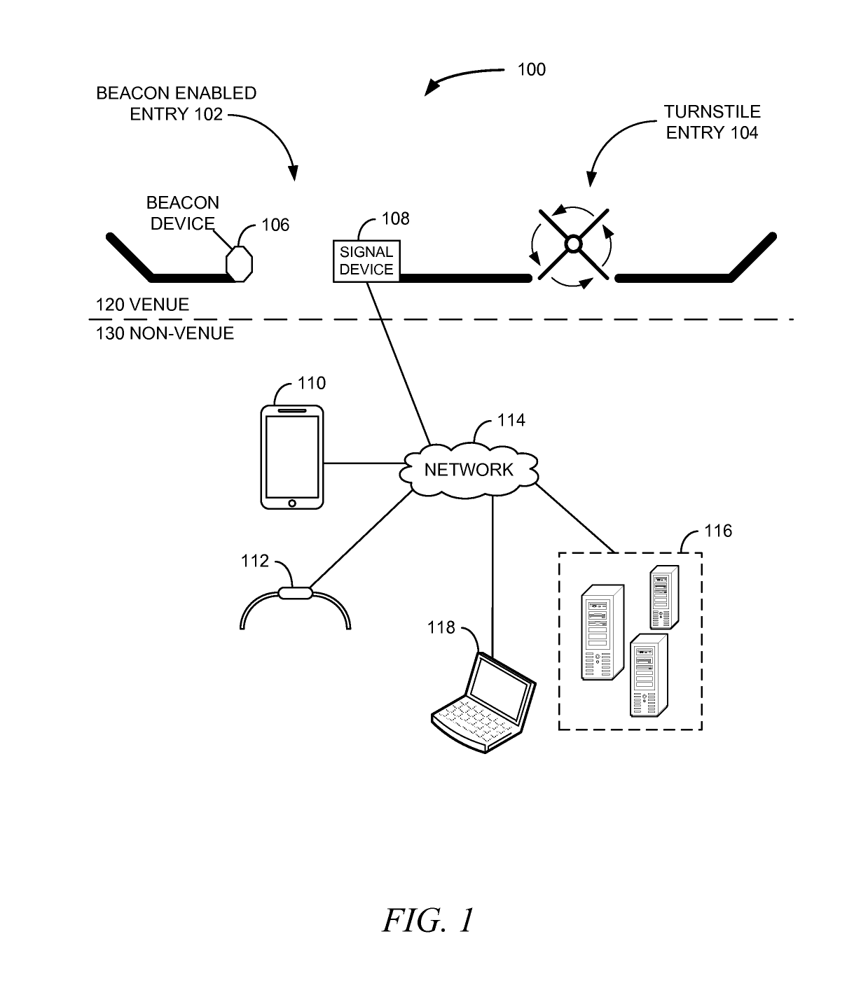

FIG. 1 is a logical block diagram of a system 100, according to an example embodiment. The system 100 is an example of an entry point validation system deployed to an access-controlled venue 120.

The access-controlled venue 120 includes a beacon enabled entry 102 and a standard turnstile entry 104. The turnstile entry 104 is a conventional entry point to the venue 120, such as where a paper-based ticket may be presented or where admission fee is paid. Entry at the turnstile 104 may require waiting in a long line, such as right before the start of a concert, ball game, when the venue 120 gates are first opened, and the like. Further, even when a payment is made or a ticket is presented visually via a mobile device app to gain entry, the process of venue 120 entry is essentially the same as with paper-based tickets.

To not only modernize entry point validation, but also to add speed, personalization, and abilities to customize validation rules, the beacon enabled entry 102 leverages beacon devices, mobile devices, and entry point control systems and devices. In some embodiments of the system 100, the beacon-enabled entry 102 at the venue 120 includes one or more beacon devices 106 and a signal device 108.

The beacon device 106, among other beacon devices 106 in some embodiments, is deployed at or near the beacon enabled entry 102 and broadcasts a radio signal encoded with entry point identifying data. The beacon device 106, in some embodiments, may include a radio transceiver device, such as a BLUETOOTH® beacon device. Among others, such beacon devices 106 are available from NCR Corporation of Duluth, Georgia. The beacon device 106 may also, or alternatively, include a WI-FI® Wireless Access Point (WAP) device in some embodiments. The radio signal, or signals, broadcast by the beacon device 106 are received by a mobile device 110, 112 of an individual desiring to enter via the entry point.

The signal device 108 is also typically deployed at or near the beacon enabled entry 102. The signal device 108 may be a stationary device installed at the entry 102 or may be a personal computer or a mobile device, such as a tablet, smartphone, smartwatch, or other mobile device such as a handheld computer. In controlled access venue 120 embodiments, such as is illustrated in FIG. 1, the signaling device 108 operates to provide an indication of whether an individual is to be granted entry to the venue 120. The indication is provided via one or more outputs of the signal device 108. The outputs may include one or more of indicator lights (e.g., a green light to grant entry and a red light to deny entry), a speaker (e.g., a first sound to grant entry and a second sound to deny entry), and a display device, such as a monitor, on which an image of person may be presented along with other data such as a name and an indication of whether to grant or deny entry.

In some embodiments, the signal device 108 includes a transceiver device that receives signals from beacon devices 106 located in proximity thereto. Based on the received signals, the signal device 108 in such embodiments transmits beacon registration data to a backend system 116 to register the location of the signal device 108 with regard to deployed beacon devices 106. The backend system 106 may then utilize the beacon device 106 and signal device 108 registration data to determine when a mobile device 110, 112 is in proximity to the signal device 108. In some such embodiments, the signal device 108 may also register signal strength data of received beacon device 106 signals. The signal strength data may be utilized in such embodiments to determine an approximate distance.

Data from which an indication on the signal device 108 of whether to grant or deny entry is generated is received via a network 114 from the backend system 116. As illustrated, the backend system 116 is located in a non-venue 130 area, but in some embodiments, the backend system 116 may be located within the venue 120. In some embodiments, the backend system 116 and the signal device 108 may be the same system and be located at the venue 120. The backend system 116 stores or has access to ticket data, user data, beacon device 106 data, mobile device 110, 112 data, and the like. The backend system 116 also includes and executes entry point validation processes to validate whether mobile device 110, 112 users are to be granted access and to communicate indications and data thereof to the signal device 108.

The system 100 also includes mobile devices 110, 112 connected to the network 114. The mobile devices 110, 112 may include one or more of smartphones 110, smartwatches 112, handheld computers, and the like. Further, although only two mobile devices 110, 112 are illustrated, in typically embodiments there are many mobile devices 110, 112. The mobile devices 110, 112 are carried or worn by individuals desiring access via the beacon-enabled entry 102. The mobile devices 110, 112 include a mobile device app deployed thereon that provides entry point validation functionality.

In an example embodiment, the entry point validation functionality on a mobile device 110, 112, operates to receive a radio signal broadcast by the beacon device 106. The mobile device 110, 112, may receive the radio signal broadcast by the beacon device 106 via a transceiver device, such as a BLUETOOTH® or WI-FI® transceiver device of the mobile device 110, 112. The received radio signal typically includes data encoded therein that identifies the beacon device 106. As the mobile device 110, 112 is in the non-venue location 130, such as outside the venue 120, the mobile device 110, 112 receives the data encoded within the beacon device 106 radio signal and generates an access request. In some embodiments, the mobile device 110, 112 app providing the entry point validation functionality includes a code or password that must be entered prior to enabling this functionality. This may be used to prevent a thief from utilizing a stolen mobile device 110, 112 to gain entry. The access request will include data representative of the beacon-enabled entry 102, such as all or a portion of data of the radio signal received from the beacon device 106 or data generated or obtained based thereon. The access request may also include other data such as a ticket identifier or season pass identifier that may have been purchased by the user on the mobile device 110, 112, via a personal computer 118, or otherwise. The access request may further include a user or user account identifier of the mobile device 110, 112 user desiring entry, and other data, depending on the particular embodiment. This other data may include password data or other user credential data. In some embodiments, the other data may also include a payment authorization as may be generated based on input received on the mobile device 110, 112 from the user. The access request, once generated, may then be transmitted from the mobile device 110, 112 via a network to the backend system 116, which will then validate the access request.

The backend system 116 receives the access request and performs validation thereon. The validation may include validating that a ticket identified in the access request is valid, has not been previously used for entry, and that the mobile device 110, 112 user presenting the ticket via their mobile device 110, 112 is the ticket holder. The validation may further include consideration of not only ticket validity, but also whether the ticket is valid at the particular date and time the ticket is presented. For example, the ticket may be valid, but the ticket presented may be valid for a current, past, or future occurrence of the ticketed event. The validation may also or further include processing of a payment for entry, validating a season pass identified in the access request, and other validation processes as may be implemented in a particular embodiment. A result of the validation process is then transmitted via the network to one or both of the signal device 108 and the user's mobile device 110, 112.

Then signal device 108, upon receipt of the access request result, performs an action depending on the type of signal device 108. The signal device 108 may simply unlock a door or activate an elevator that permits entry. In other embodiments, the signal device 108 may be a signaling device that illuminates green when entry is authorized and red when entry is not authorized. Beacon enabled entry 102 personnel may then allow the user to pass or prevent them from doing so. In some embodiments, the signal device 108 may be more sophisticated, including a display device, such as a monitor. The signal device 108 in such embodiments may receive additional data in the access request result from the back end system or access additional data based on data received in the access request result. This additional data may include an image and a name of the user that is either to be allowed or denied entry. The image and name may then be presented via the display enabling personnel to quickly identify and refer to the user by name.

Some additional embodiments of the system 100 may not include the signal device 108. In such embodiments, the backend system 116 may transmit an image, alpha-numeric code, or other indicator data to the mobile device 110, 112 which may be presented thereon. The image, alpha-numeric code, or other indicator may then be presented to an agent at the beacon enabled entry 102. The image, alpha-numeric code, or other indicator may be active for a given event, for a defined period, and the like. In such instances, the gate agent will be aware of the valid code or codes.

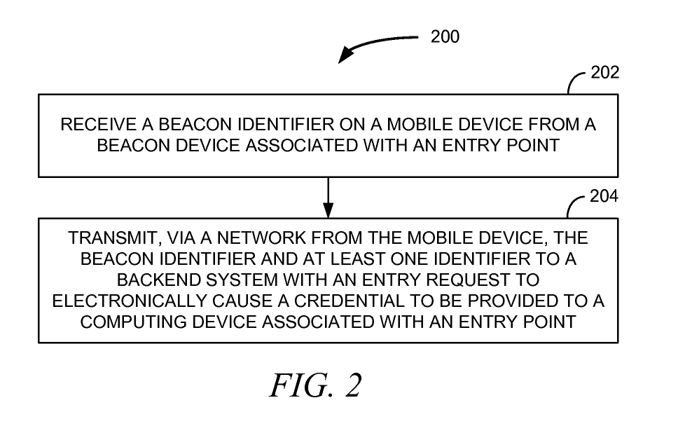

FIG. 2 is a block flow diagram of a method 200, according to an example embodiment. The method 200 is an example of a method that may be performed on a mobile device, such as by a mobile device app deployed to and that executes on a mobile device 110, 112 of FIG. 1.

The method 200 includes receiving 202 a beacon identifier on a mobile device from a beacon device associated with an entry point. The method 200 further includes transmitting 204, via a network from the mobile device to a backend system, the beacon identifier and at least one identifier with an entry request to cause a credential to be provided to a computing device associated with an entry point. The at least one identifier may include one or more of a user account identifier, a password, a ticket identifier, a mobile device identifier, and the like. The at least one identifier may be stored in a memory of the mobile device, be received as input from a user, retrieved from a network location, or otherwise be retrieved or obtained.

Some embodiments further include receiving, via the network on the mobile device, a reply to the entry request and presenting, on a display of the mobile device, a view generated based upon the received reply to the entry request. This view may include an indication to proceed through the entry point when the entry request has been validated or an indication that the entry request has not been validated. The view may also or alternatively include an entry credential, such as a barcode that may be scanned to gain entry. In some embodiments, when the entry request has not been validated, an option to purchase a ticket may be presented. The mobile device app may then be utilized in some such embodiments to purchase a ticket and a new access request may be generated, transmitted, and processed accordingly.

In some embodiments of the method 200, and some other embodiments herein, upon receipt of an access request validation, a command may be received from the backend system or the validation request may automatically trigger additional functionality. The command or triggered functionality in some embodiment may be to disable at least one function of the mobile device, such as to disable a camera, ringer, or other audio output of the mobile device. The mobile device app may then issue commands on the mobile device to disable the functionality.

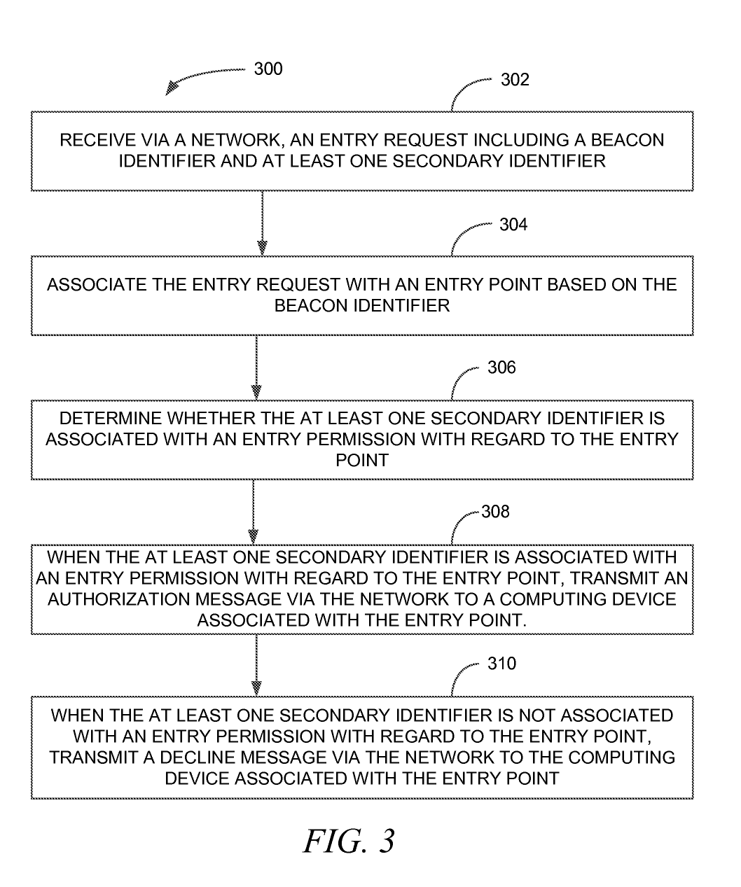

FIG. 3 is a block flow diagram of a method 300, according to an example embodiment. The method 300 is an example of a method performed in some embodiments on a backend system, such as the backend system 116 of FIG. 1, to validate an entry request.

The method 300 includes receiving 302, via a network, an entry request including a beacon identifier and at least one secondary identifier. The entry request may be received 302 via the network from an app that executes on a mobile device. The method 300 further includes associating 304 the entry request with an entry point based on the beacon identifier and determining 306 whether the at least one secondary identifier is associated with an entry permission with regard to the entry point. In such embodiments, when the at least one secondary identifier (e.g., one or more of an account number, mobile device identifier, ticket number, password, etc.) is associated with an entry permission with regard to the entry point, transmitting 308 an authorization message, via the network to a computing device associated with the entry point. Conversely, when the at least one secondary identifier is not associated with an entry permission with regard to the entry point, transmitting 310 a decline message via the network to the computing device associated with the entry point.

In some embodiments, associating 304 the entry request with the entry point includes retrieving an entry point identifier from a database with the beacon identifier as at least a portion of a data retrieval key. In some such embodiments, retrieving the entry point identifier from the database further includes at least one of a date and time as an addition portion of the data retrieval key. The backend system in such embodiments may apply validation rules that take into account one or both of the date and time in determining 306 whether to validate the received 302 access request.

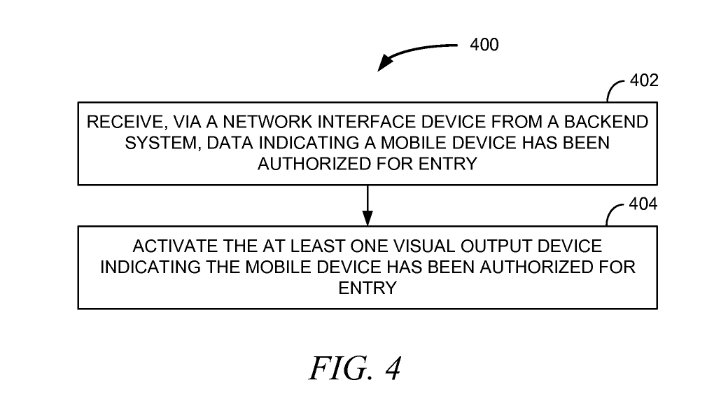

FIG. 4 is a block flow diagram of a method 400, according to an example embodiment. The method 400 is an example of a method that may be performed by a signal device deployed at an entry point, such as the signal device 108 of FIG. 1. The method 400 includes receiving 402, via at least one network interface device from a backend system, data indicating a mobile device has been authorized for entry. The method 400 further includes activating 404 at least one visual output device indicating the mobile device has been authorized for entry. The method may further output a signal via an audio output device, such as a speaker indicating an authorized entry or a denial.

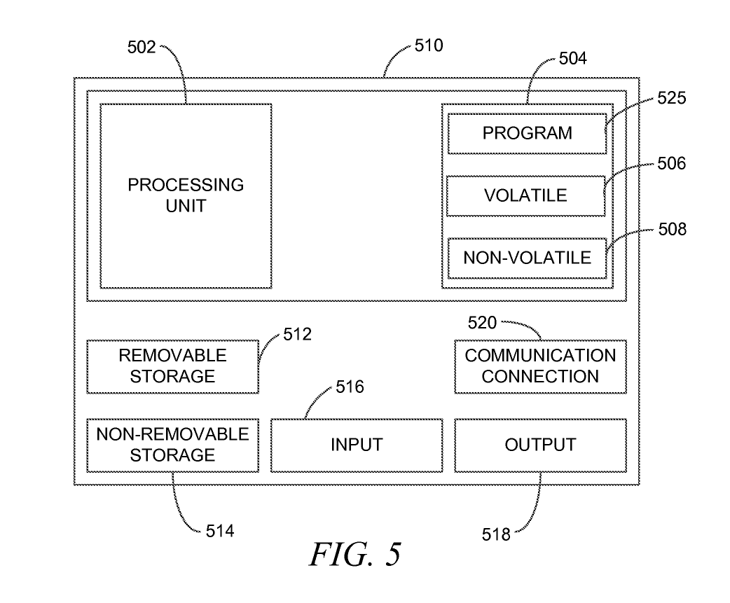

FIG. 5 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 510, may include a processing unit 502, memory 504, removable storage 512, and non-removable storage 514. Although the example computing device is illustrated and described as computer 510, the computing device may be in different forms in different embodiments. For example, the computing device may instead be a smartphone, a tablet, smartwatch, or other computing device including the same or similar elements as illustrated and described with regard to FIG. 5. Devices such as smartphones, tablets, and smartwatches are generally collectively referred to as mobile devices. Further, although the various data storage elements are illustrated as part of the computer 510, the storage may also or alternatively include cloud-based storage accessible via a network, such as the Internet.

Returning to the computer 510, memory 504 may include volatile memory 506 and non-volatile memory 508. Computer 510 may include —or have access to a computing environment that includes a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 510 may include or have access to a computing environment that includes input 516, output 518, and a communication connection 520. The input 516 may include one or more of a touchscreen, touchpad, mouse, keyboard, camera, one or more device-specific buttons, one or more sensors integrated within or coupled via wired or wireless data connections to the computer 510, and other input devices. The computer 510 may operate in a networked environment using a communication connection 520 to connect to one or more remote computers, such as database servers, web servers, and other computing device. An example remote computer may include a personal computer (PC), server, router, network PC, a peer device or other common network node, or the like. The communication connection 520 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 520 may also or alternatively include a transceiver device, such as a BLUETOOTH® device that enables the computer 510 to wirelessly receive data from and transmit data to other BLUETOOTH® devices.

Computer-readable instructions stored on a computer-readable medium are executable by the processing unit 502 of the computer 510. A hard drive (magnetic disk or solid state), CD-ROM, and RAM are some examples of articles including a non-transitory computer-readable medium. For example, various computer programs 525 or apps, such as one or more applications and modules implementing one or more of the methods illustrated and described herein or an app or application that executes on a mobile device or is accessible via a web browser, may be stored on a non-transitory computer-readable medium.

Another embodiment is in the form of a system, such as the signal device 108 of FIG. 1. The system of this embodiment includes at least one network interface device, at least one visual output device, at least one processor, and at least one memory. The system includes an instruction set, stored in the memory and executable by the at least one processor to perform data processing activities. The data processing activities in some embodiments include receiving, via the at least one network interface device from a backend system, data indicating a mobile device has been authorized for entry. The data processing activities further include activating the at least one visual output device indicating the mobile device has been authorized for entry.

In some embodiment, the system further includes a transceiver device that operates as a radio signal beacon, such as a BLUETOOTH® beacon device, to broadcast an identifier registered in a backend system to at least one of the system and an entry point where the system is deployed.

In an additional embodiment of the system, the at least one visual output device includes a display device. Further, the data received from the backend system may include an image of a user of the mobile. The system when activating the at least one visual output device may then present the image included in the data received from the backend system.

In some of these and other embodiments of the system, the system may include an audio output device. In such embodiments, the data processing activities may further include outputting an audio signal via the audio output device indicating the mobile device has been authorized for entry.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving a beacon identifier on a mobile device from a beacon device associated with an entry point;
transmitting, via a network from the mobile device, the beacon identifier and at least one identifier to a backend system with an entry request to electronically cause a credential to be provided to a computing device associated with an entry point.

2. The method of claim 1, further comprising:
receiving, via the network on the mobile device, a reply to the entry request; and
presenting, on a display of the mobile device, a view generated based upon the received reply to the entry request.

3. The method of claim 2, further comprising:
receiving, via the network from the backend system, a command to disable at least one function of the mobile device; and
disabling the at least one function of the mobile device.

4. The method of claim 2, wherein the view presented on the display of the mobile device is an entry credential.

5. The method of claim 4, wherein the entry credential is a barcode.

6. The method of claim 1, wherein the beacon identifier is received via a wireless transceiver device of the mobile device.

7. The method of claim 1, wherein the at least one identifier is a mobile device user account identifier.

8. The method of claim 6, wherein the at least one identifier further includes a ticket identifier stored in and retrieved from a memory of the mobile device.

9. A method comprising:
receiving, via a network, an entry request including a beacon identifier and at least one secondary identifier;
associating the entry request with an entry point based on the beacon identifier;
determining whether the at least one secondary identifier is associated with an entry permission with regard to the entry point;
when the at least one secondary identifier is associated with an entry permission with regard to the entry point, transmitting an authorization message, via the network to a computing device associated with the entry point.

10. The method of claim 9, wherein when the at least one secondary identifier is not associated with an entry permission with regard to the entry point, the method further comprises:
transmitting a decline message via the network to the computing device associated with the entry point.

11. The method of claim 9, wherein the entry request is received via the network from an app that executes on a mobile device.

12. The method of claim 11, wherein the at least one secondary identifier is an account identifier.

13. The method of claim 9, wherein associating the entry request includes:
retrieving an entry point identifier from a database with the beacon identifier as at least a portion of a data retrieval key.

14. The method of claim 13, wherein:
retrieving the entry point identifier from the database further includes at least one of a date and time as an addition portion of the data retrieval key.

15. The method of claim 9, wherein when the at least one secondary identifier is associated with an entry permission with regard to the entry point the method further comprises:
retrieving additional data based on the at least one secondary identifier; and
transmitting, via the network, at least a portion of the additional data to the computing device associated with the entry point.

16. The method of claim 15, wherein the additional data retrieved based on the at last one secondary identifier includes an image file that will be presented on a display of the computing device associated with the entry point indicating a person represented in the image file is authorized to pass the entry point.

17. A system comprising:
at least one network interface device;
at least one visual output device;
at least one processor;
at least one memory; and
an instruction set, stored in memory and executable by the at least one processor to perform data processing activities, the data processing activities comprising:
receive, via the at least one network interface device from a backend system, data indicating a mobile device has been authorized for entry; and
activate the at least one output device indicating the mobile device has been authorized for entry.

18. The system of claim 17, further comprising:
a transceiver device that operates as a radio signal beacon to broadcast an identifier registered in a backend system to at least one of the system and an entry point where the system is deployed.

19. The system of claim 17, wherein:
the at least one visual output device includes a display device;
the data received from the backend system includes an image of a user of the mobile device; and
activating the at least one visual output device includes presenting the image included in the data received from the backend system.

20. The system of claim 17, wherein the output device is an audio output device, the data processing activities further comprising:
outputting an audio signal via the audio output device indicating the mobile device has been authorized for entry.
